(19) United States
(12) Patent Application Publication
(10) Pub. No.: US 2013/0084556 A1
(43) Pub. Date: Apr. 4, 2013

(54) SYSTEM AND METHOD FOR SIMULATING GOODS IN BULK

(71) Applicants: Paul Giampavolo, Newton, NJ (US); Christopher M. Johnson, Glen Allen, VA (US)

(72) Inventors: Paul Giampavolo, Newton, NJ (US); Christopher M. Johnson, Glen Allen, VA (US)

(21) Appl. No.: 13/303,805

(22) Filed: Nov. 23, 2011

Related U.S. Application Data
(63) Continuation-in-part of application No. 29/403,052, filed on Sep. 30, 2011.

(51) Int. Cl. G09B 25/00

(52) U.S. Cl. 434/365

(57) ABSTRACT

A retail display provides a simulation of stacked, palletized goods. The display simulates stacked bulk goods in bulk with a fabric cover draped on a tubular frame, where graphics and/or designs are applied to the fabric cover to simulate images of goods or stacks of goods. The fabric cover can be secured to the frame, both of which can be secured separately or together to a pallet as a support. The fabric cover and frame can be implemented in various shapes and sizes to accommodate different pallet sizes while simulating stacked bulk goods. The display eliminates the risks involved in providing actual bulk goods in palletized form for marketing and promotion purposes. The fabric cover is provided with various features, such as wind slits or rain holes to permit the display to withstand various environmental conditions.

### STATEMENT REGARDING FEDERALLY SPONSORED RESEARCH OR DEVELOPMENT

(N/A)

### BACKGROUND OF THE INVENTION

Retailer displays often seek to capture the attention of the public regarding products or sales offered by the retailer. In some instances, retailers offer goods as part of a display, where the goods are stacked in bulk. The bulk goods, often stacked on a pallet to permit ease of transport, often serve several purposes. For example, the product can be relatively easily obtained by a customer for purchase, by the customer selecting the product themselves from the bulk display. In addition, the bulk arrangement serves as a display for the product that is often easily recognizable by the public, and can inform the public of the availability of the product, or of sales or specials for the product.

One arrangement often used by retailers to help market products is to place bulk goods outside a retail establishment.

By placing the bulk goods outside of the store, the retailer can attract attention to the product, potentially for consumers that are not presently intending to or actually shopping at the store. Again, the bulk items are often placed on pallets for ease of transportation, and can also often be used to support sales banners or flyers to inform potential customers about specials or sales for the product.

The bulk goods being placed on the pallet to permit ease of transportation is often helpful to the retailer in terms of preparing the store for opening and closing. The retailer will often transport palletized bulk goods from inside a store location to an outside location to prepare for opening the store, or after the store is opened. The retailer also often returns the bulk palletized goods to an interior of the store before or after the end of store hours. The purpose of the transport of the bulk goods, which is often done using a forklift and forklift operator, is to ensure that the goods are secured when the store is closed, and to make the goods available for sales and marketing purposes when the store is open.

Generally, the retailer does not wish to leave the bulk goods outside of the store when the store is closed, due to security concerns. However, it can be sometimes challenging to transport bulk goods from inside the store to a display area outside the store, and then return the bulk goods to the inside of the store at the time the store is closing. The challenge can be somewhat significant if there are a number of bulk goods that are to be transported between the inside of the store and a display area outside of the store. Therefore, in addition to the security risks discussed above, retailers face challenges in promoting goods with exterior bulk displays that can represent handling costs.

In addition to the above-mentioned challenges, bulk goods being placed outside the store are somewhat susceptible to damage from an outdoor environment, as well as from mishaps that can occur with vehicles or customers accidentally contacting and damaging the bulk goods. For example, snow, rain, direct sunlight, extremes of high and low temperatures and other environmental conditions can lead to damage to goods or packaging material, resulting in a loss for the retailer. Moreover, bulk goods outside a store are often near parking areas, with the attendant risk of being impacted by vehicles, resulting in damage to the goods or packaging. Likewise, pedestrian shoppers may hit the bulk goods with shopping carts or carriages, for example, again resulting in possible damage to goods or packaging. It would be desirable to attain the advantages of bulk good advertising and marketing at an exterior of a retail establishment, without the attendant risks of loss or damage.

### BRIEF SUMMARY OF THE INVENTION

In accordance with the present disclosure, systems and methods for simulating bulk goods are described. A simulated bulk goods display is provided for simulating the appearance of bulk goods for retail purposes, such as marketing and promotion. The simulated bulk goods may be embodied in a relatively inexpensive form to permit retailers to reduce the costs of marketing and promotion in relation to bulk goods displays. The bulk good simulation also avoids the risks associated with security or damage when maintaining bulk product outside the store or when the store is closed. The simulated bulk goods also provides the function of marketing or promoting products, as well as drawing attention to the store and specials or sales offered by the store.

According to an aspect of the present disclosure, the simulated bulk goods display is embodied in a fabric cover draped over a framework to give the appearance of a three dimensional volume of a stack of products as bulk goods. The fabric may be patterned with designs that give the appearance of products stacked as bulk goods. The designs provided to the fabric may simulate products that are being marketed or promoted by the store, so that the bulk goods display appears as a stack of the products being marketed or promoted.

According to another aspect, the bulk goods display includes a frame that may be composed of tubular members joined together to form a three dimensional volume over which a fabric may be draped to simulate stacked products as bulk goods. The tubular members may be composed of various corner and side elements with tubular connection regions being configured to receive other tubular members to permit construction of the frame. According to an aspect of the disclosure, the frame describes a three dimensional volume that is a right rectangular space. According to another aspect, the frame has a base region, the area of which is greater than about one square foot.

According to another aspect, the present disclosure provides a thin pliable material shaped to simulate products stacked in bulk. The material can be arranged around a frame to give the appearance of products stacked in bulk. The material may include attachment mechanisms to permit the material to be attached to the frame or to base elements upon which the frame may rest. In addition, or alternately, attachments may be provided to the frame and/or material placed around the frame to permit the frame and/or material to be secured to a pallet.

According to another aspect, the frame, and/or material placed around the frame, can be reconfigured for different size bulk displays by adjusting the tubular elements of the frame and the material placed around the frame. The framework and material may, for example, be sized to the pallet to more closely simulate products stacked in bulk on a pallet. Moreover, the appropriately sized frame and material can be attached to the pallet to permit the display to be transported in the same way that stacked bulk goods on a pallet might be transported.

### BRIEF DESCRIPTION OF THE SEVERAL VIEWS OF THE DRAWINGS

The presently disclosed systems and methods are described in greater detail below, with reference to the accompanying drawings, in which:

FIGS. 1A and 1B are perspective views of a display configuration in accordance with exemplary embodiments of the present disclosure;

FIG. 2 is a perspective view of a central frame joint in accordance with an exemplary embodiment of the present disclosure;

FIG. 3 is a perspective view of a corner frame joint in accordance with an exemplary embodiment of the present disclosure;

FIG. 4 is a perspective view of a central frame joint in accordance with an exemplary embodiment of the present disclosure;

FIGS. 5 and 6 are perspective views of corner frame joints in accordance with an exemplary embodiment of the present disclosure;

FIG. 7A is a perspective view of a connector in accordance with an exemplary embodiment of the present disclosure; and

FIG. 7B is a longitudinal cross-sectional view of the connector shown in FIG. 7A.

### DETAILED DESCRIPTION

This application is a continuation-in-part of application Ser. No. 29/403,052, filed Sep. 30, 2011, entitled Simulated Bulk Goods Display, the entire contents of which is hereby incorporated herein by reference.

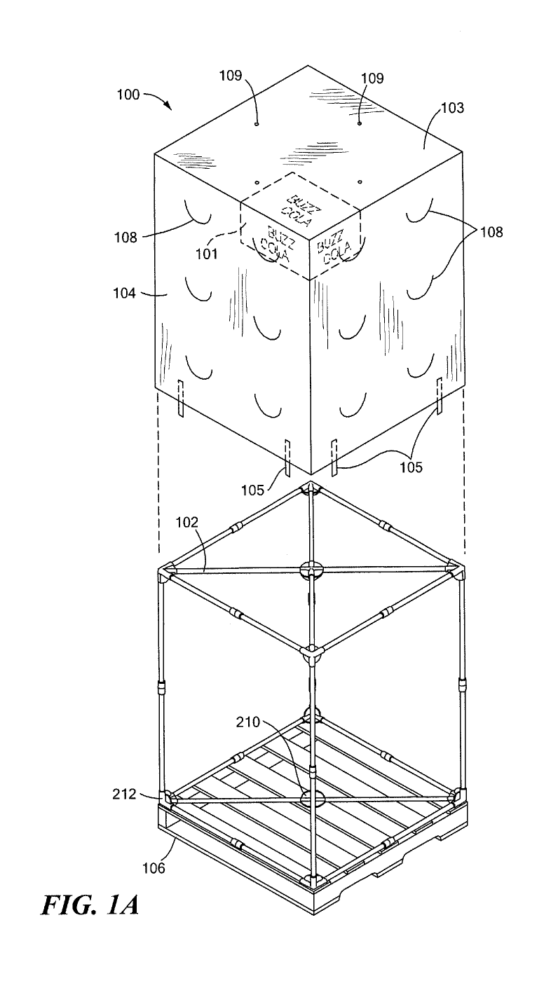

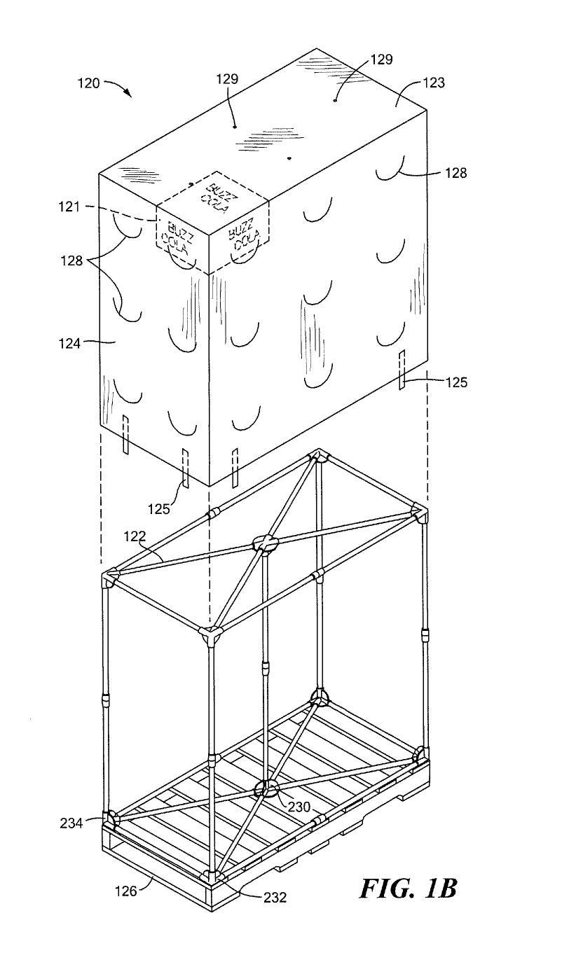

Referring now to FIGS. 1A and 1B, exemplary embodiments of the present disclosure are illustrated as displays 100 and 120, respectively. Displays 100, 120 each include a respective frame 102, 122, that supports a respective fabric cover 104, 124. Each of displays 100, 120 is sized and shaped to conform to a respective pallet 106, 126. Although shown incompletely in FIGS. 1A, 1B, each of fabric covers 104, 124 is provided with indicia to make each fabric cover 104, 124 appear as a stack of goods in bulk. For example, fabric cover 104, 124 may be provided with graphics 101, 121 that simulate boxes of soft drinks, or with a soft drink company logo or with other designs and/or indicia that simulate an outward appearance of a stack of products.

Fabric covers 104, 124 include wind slits 108, 128 that are in the form of half circles to create openings through fabric cover 104, 124. Wind slits 108, 128 provide a path for wind to pass through displays 100, 120 to reduce wind force exerted on displays 100, 120. Wind slits 108, 128 thus contribute to reducing the loading on frames 102, 122 to permit display 100, 120 to remain upright as a three dimensional right rectangular space. Winds slits 108, 128 are generally evenly distributed around upright surfaces of fabric cover 104, 124, and may be spaced approximately 16 inches from each other on a given surface of fabric cover 104, 124. Wind slits 108, 128 may be provided as half circles, as illustrated in FIGS. 1A, 1B, or in any other shape that permits the fabric of fabric cover 104, 124 to be displaced to form a passage for wind.

Fabric covers 104, 124 also include rain holes 109, 129 arranged on an upper surface 103, 123 of fabric covers 104, 124. Rain holes 109, 129 are provided in locations that may be unsupported by frames 102, 122, where the potential for water collection in an outdoor environment is potentially greater. Rain holes 109, 129 are through openings in respective surfaces 103, 123 to permit water to drain from surfaces 103, 123 rather than potentially collect in pools.

Fabric covers 104, 124 may also be composed of a porous, permeable or semi-permeable material to permit fluid passage, including passage of air and water. For example, fabric covers 104, 124 may be composed of loosely woven or knitted material that provides for gaps to permit passage of air and water, which can obviate the provision of wind slits 108, 128 or rain holes 109, 129. Other types of known fluid permeable, semi-permeable or otherwise porous materials may be used in accordance with the present disclosure, as is know to those of ordinary skill in the art. As an example, fabric covers 104, 124 may be composed of semi-rigid screen material that permits the passage of air and water to decrease wind force experienced by displays 100,120, as well as avoid pooling of liquid on a top surface of displays 100, 120. Such material can be provided with graphics or designs that do not interfere with the porous, permeable or semi-permeable nature of the material, while also presenting the appearance of a stack of bulk goods.

Fabric covers 104, 124 include straps 105, 125 for securing fabric covers 104, 124 to frames 102, 122 and/or pallets 106, 126.

Straps 105, 125 may have any type of fastener suitable for securing straps 105, 125 to frames 102, 122 and/or pallets 106, 126, such as hook and loop, snap, buckle, and any other type of fastener that can function in such capacity. Straps 105, 125 help to maintain fabric covers 104, 124 in position on frames 102, 122 to maintain the appearance of stacked bulk goods. Straps 105, 125 may also be used to contribute to retaining fabric covers 104, 124 to respective pallets 106, 126, as well as being used to retain frames 102, 122 to respective pallets 106, 126.

Frames 102, 122 are illustrated in FIGS. 1A, 1B as being constructed of tubular members joined together at various joints, such as corner joints 212, 232 and central joints 210, 230. Display 100 in FIG. 1A is illustrated as having a generally square horizontal cross section, so that central joint 210 and corner joint 212 form right angles with upright and vertical members that meet at respective central and corner joints 210, 212.

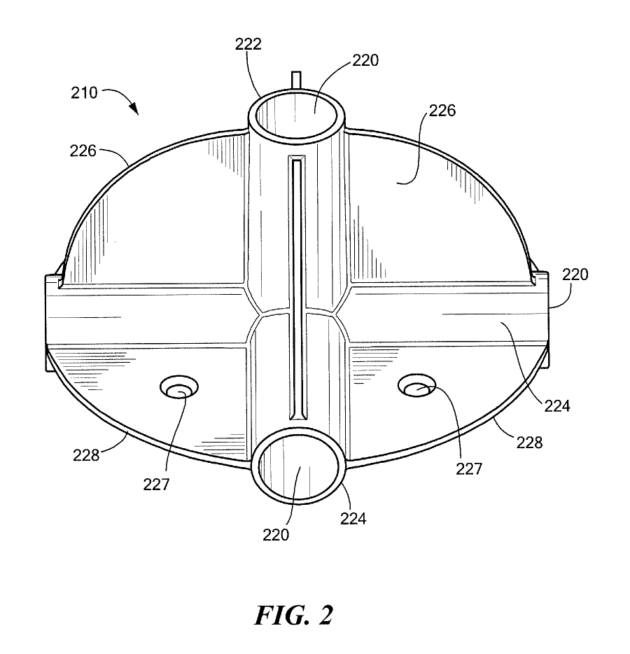

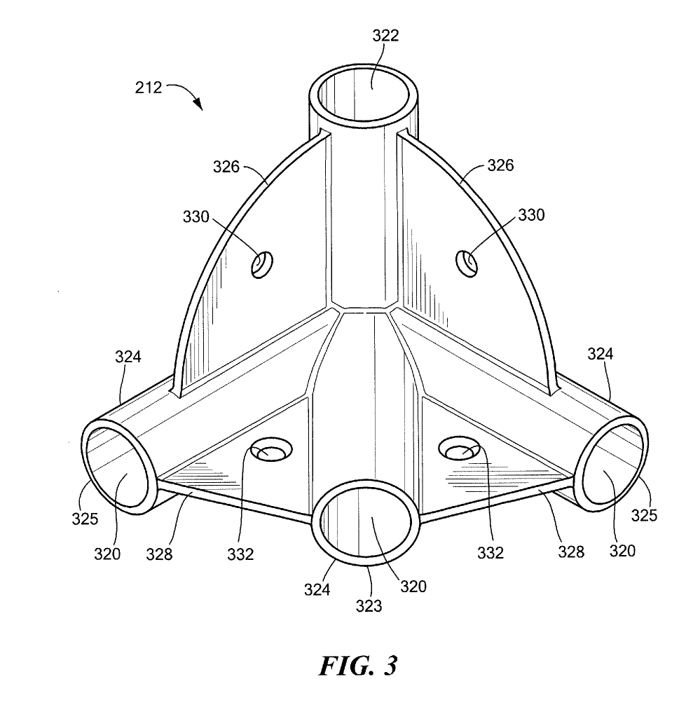

Referring to FIGS. 2 and 3, central joint 210 and corner joint 212 are respectively illustrated. In FIG. 2, central joint 210 provides five receptacles 220 for tubular members used to form frame 102. Receptacles 220 are arranged at right angles with an adjoining receptacle 220. Central joint 210 is illustrated as being symmetrical with respect to a vertical plane bisecting a central receptacle 222 and at least two horizontal receptacles 224. Central joint 210 may be oriented to have central receptacle 222 directed vertically upward or downward, or horizontally, to permit connection with tube members to construct frame 102. Central joint 210 also includes upright panels 226 that are arranged between central receptacle 222 and base receptacles 224 to increase rigidity and support for maintaining receptacles 220 in right angle orientation with each other. Central joint 210 also is provided with base panels 228 that provide rigidity and support for maintaining base receptacles 224 in a right angle orientation with each other. Base panels 228 also include openings 227, which are through openings that can accept screws, nails or other fasteners to securely fasten central joint 210 to pallet 106 (FIG. 1A), for example. Openings 227 may also be used to secure fabric cover 104 to central joint 210, especially when central joint 210 is oriented with central receptacle 222 in a downward vertical direction, or in a horizontal direction.

According to an exemplary embodiment of the present disclosure, receptacles 220 may be configured to be tapered or ribbed to obtain a compression fit with an inserted tubular member used to construct frame 102. Receptacles 220 are thus configured to function as retainers to fasten and secure tubular members to central joint 210. Any type of known configuration for receptacles 220 and ends of the tubular members that permits cooperation between the tubular members and receptacles 220 to fasten the tubular members to central joint 210 may be used. For example, an outer diameter of an end of a tubular member may be ribbed (not shown) to cooperate with ribs or a taper (not shown) disposed on an inner diameter of receptacles 220. In general, the tubular members are joined to central joint 210 to contribute to forming a generally rigid structure for frame 102 to permit display 100 to bear loading forces in the form of wind or water, including snow or ice, without separating the tubular member from central joint 210.

Referring now to FIG. 3, corner joint 212 is configured to provide the same features and configurations as central joint 210 described above, in the form of a corner support and connecter. Corner joint 212 includes receptacles 320, including corner receptacle 322 and base receptacles 324. Base receptacles 324 include two outer receptacles 325 and an inner receptacle 323. Outer receptacles 325 are at right angles to each other, as well as being at right angles to corner receptacle 322, thereby permitting the formation of a corner of frame 102.

Corner joint 212 also includes upright panels 326 disposed between corner receptacle 322 and each of outer receptacles 325. Panels 326 contribute to reinforcing corner joint 212, and help to provide rigidity to frame 102 by limiting flexibility of corner receptacle 322 and outer receptacles 325. The provision of panels 326 contributes to the support, or loading, that corner joint 212 can supply or bear. Accordingly, panels 326 contribute to permitting corner joint 312, and thus frame 102, to withstand greater applied wind force loading or weight loading that may occur with water, snow or ice, or other weight loading being placed upon frame 102.

Corner joint 212 further includes an inner receptacle 323 located at a forty-five degree angle between outer receptacles 325. Inner receptacle 323 is so arranged to provide a connecting joint receptacle for tubular members extending toward a center of frame 102, which may connect with central joint 210, for example. Panels 328 are disposed between inner receptacle 323 and outer receptacles 325 to promote rigidity and increase load bearing characteristics for corner joint 212. Panels 328 limit the amount of flexibility for and between inner receptacle 323 and outer receptacles 325.

Panels 326, 328 include respective openings 330, 332, which may be configured as through openings. Openings 330, 332 permit corner joint 212 to be fastened to a support or other object, to stabilize corner joint 212 with respect to a location, for example. Openings 330, 332 may also be used to permit fabric cover 104 to be fastened to frame 102, such as may be achieved with wire, zip ties, screws, bolts and nuts, and any other type of fastener suitable for use with openings 330, 332.

Corner joint 212 can be arranged in any particular orientation to form a corner of frame 102, and may be positioned at a top or bottom corner of frame 102 to permit tubular members to be joined to other corner joints 212, or to central joint 210. That is, corner joint 212 represents its own complement with respect to being able to be located at any corner of frame 102. Corner joint receptacles 320 may be configured to accept and securely fasten a tubular member to permit secure construction of frame 102. Corner joint receptacles 320 may be tapered or ribbed on an inner diameter to provide a secure fastening for tubular members of frame 102, or may be configured in any other way to permit tubular members to be fastened to corner joint 212. For example, ends of tubular members may be tapered or ribbed, or have openings through which a fastener may be passed in conjunction with cooperative openings (not shown) in corner joint receptacles 320 to attach the tubular members to corner joint 212.

Although the embodiment illustrated in FIG. 1A of frame 102 shows the use of corner joints 212 and central joints 210, other types of joints and connecters may be used in the construction of frame 102. For example, a joint may be disposed midway between a vertical extent of tubular members of frame 102. Such a joint disposed along the vertical extent of the tubular members may include a receptacle to permit connection of a tubular member extending diagonally in a horizontal direction into the space defined by display 100, and may terminate on another joint centrally disposed on frame 102.

The construction of frame 102 is modular for ease of distribution, so that display 100 can be constructed on-site with relative ease. This construction avoids the distribution of display 100 as a whole, which would take up a large, mostly empty volume, as well as involving additional shipping costs. Frame 102 can also be secured to pallet 106, such as by using openings 227 and 332, through which fasteners such as screws or nails can be driven to secure corner joint 212 and/or central joint 210 to pallet 106. Fabric cover 104 may also be secured to frame 102, such as by using openings 330 in corner joint 212 to secure fabric cover 104 to frame 102 with suitable fasteners. Fabric cover 104 may also be secured to frame 102 using straps 105, which straps may also be used to secure fabric cover 104 to pallet 106. Pallet 106 forms a stable base for supporting display 100 to contribute to resisting wind and weight loading, for example. Other types of supports may also be used, however, by providing display 100 on pallet 106, display 100 more closely simulates a stacked group of palletized goods. In addition, display 100 can be transported using conventional pallet moving equipment such as forklifts and fork trucks.

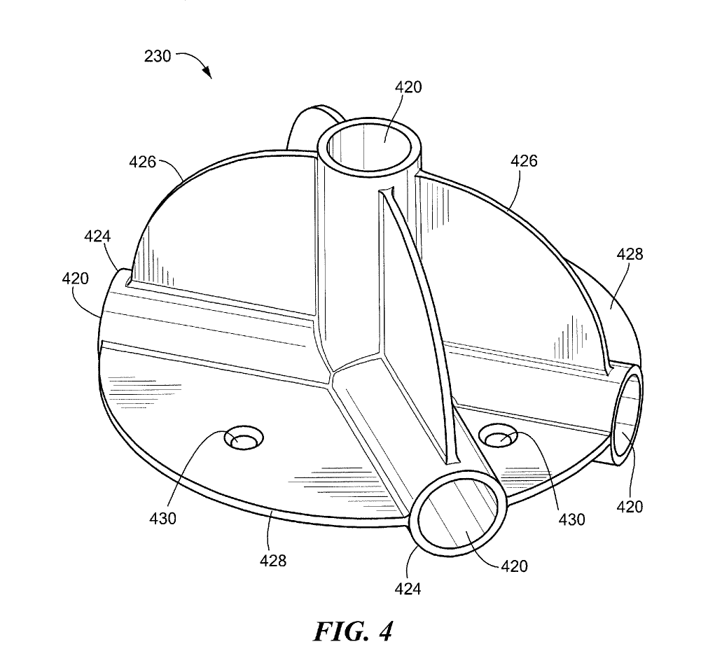

Referring now to FIG. 4, a central joint 230 for use with display 120 (FIG. 1B) is illustrated. Central joint 230 is substantially similar to central joint 210 in function and design, however, central joint 230 is configured to be used with display 120 to construct frame 122. Accordingly, central joint 230 includes receptacles 420 that function similarly to receptacles 220 of central joint 210. Central joint 230 also includes panels 426 and 428 in respective vertical and horizontal orientations as shown in FIG. 4, that are configured to function similarly to panels 226 and 228 of central joint 210. Panels 428 of central joint 230 also feature openings 430 that feature the same functionality as openings 227 in panels 228 of central joint 210 as described above. Central joint 230 differs from central joint 210 in that central joint 230 has adjoining base receptacles 424 that are arranged at an angle of approximately 52.4 degrees, and an angle of approximately 127.6 degrees. By providing such an arrangement for base receptacles 424, central joint 230 can be used to receive tubular members in a center of frame 122, which differs in size and shape from frame 102 by having a rectangular horizontal cross section as opposed to the generally square horizontal cross section of frame 102.

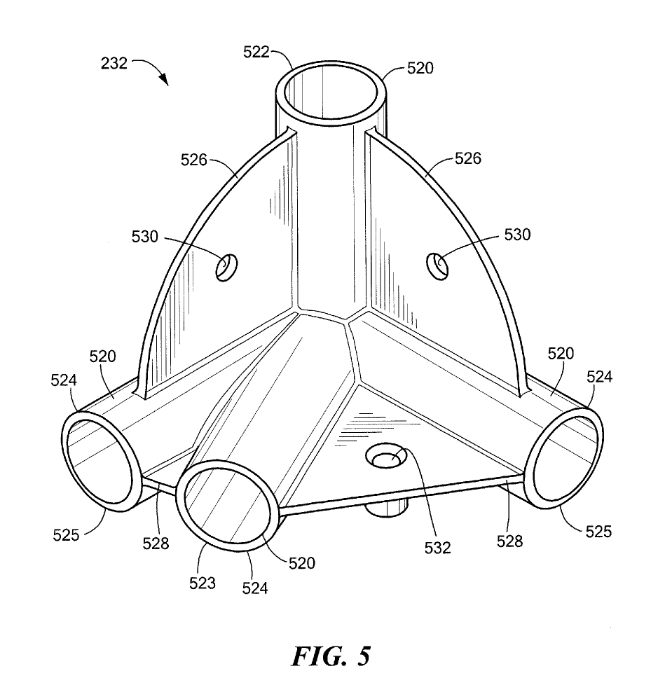

Referring now to FIG. 5, corner joint 232 is illustrated with many of the same features and functions as corner joint 212 (FIG. 3). For example, corner joint 232 includes receptacles 520, with a corner receptacle 522 and base receptacles 524, which provide the same function as their counterparts described with respect to corner joint 212. Corner joint 232 includes an inner receptacle 523 and outer receptacles 525, where inner receptacle 523 is arranged to have differing angles with respect to outer receptacles 525. For example, inner receptacle 523 can be arranged with respect to one outer receptacle 525 with an angle of approximately 26.2 degrees, while having an angular relationship with another outer receptacle 525 of approximately 63.8 degrees. The arrangement of base receptacles 524 with the particular angle separation permits corner joint 232 to direct inserted tubular members at an angle that is appropriate to permit cooperation with central joint 230 of frame 122. The angular arrangement of base receptacles 524 is different from that of corner joint 212 to reflect the different shape and size of frame 122 having a generally rectangular horizontal cross section rather than a generally square horizontal cross-section.

Corner joint 232 includes panels 526 and 528 that contribute to providing rigidity for corner joint 232 and support for loading forces that may be applied to frame 122. Panels 526 include openings 530 that may be used to secure frame 122 to pallet 126, or fabric cover 124 to frame 122. An opening 532 in one of panels 528 may also be used to permit corner joint 232 to be securely fastened to pallet 126 and/or fabric cover 124.

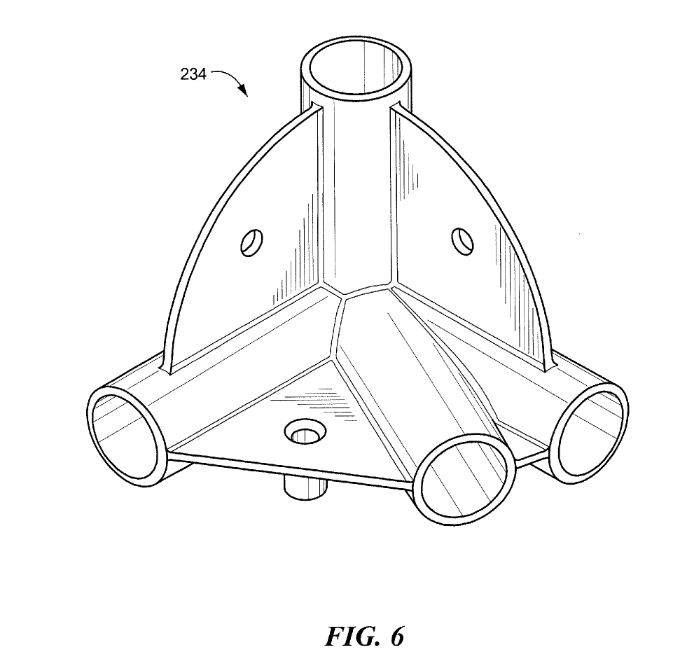

Referring now to FIG. 6, a corner joint 234 is illustrated as being a complement to corner joint 232. Corner joint 232 and 234 can be thought of as mirror images of each other, with attendant features and functions provided by the components described above with respect to corner joint 232. Corner joints 232 and 234 permit construction of frame 122 with a rectangular horizontal cross section, where the angle of tubular members extending horizontally from corner joints 232, 234 are different than 45 degrees, which represents the special case of corner joint 212 (FIG. 3). Because frame 122 has a rectangular horizontal cross section, corner joints 232, 234 have adjacent base receptacles, e.g., base receptacles 524, that are separated by angles that are other than 45 degrees. Accordingly, corner joint 232 and a complement corner joint 234 are used to form frame 122 that has a rectangular horizontal cross section.

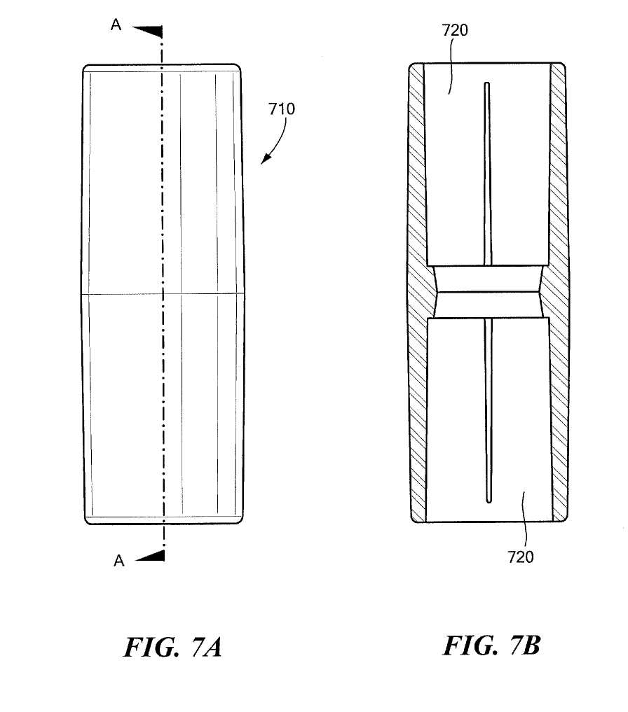

Referring now to FIG. 7, a connector 710 for joining tubular members is illustrated. Connector 710 provides two generally cylindrical recesses 720 that can accommodate tubular members, where cylindrical recesses 720 generally oppose each other to permit tubular members to be aligned in a same direction. With the insertion of tubular members into each of cylindrical recesses 720, a tubular member with an increased span is effectively created. Connector 710 thus provides the advantage of permitting tubular members to be assembled together to obtain different overall lengths. With this modular construction, a greater number of portions of frame 122 can be duplicated for use in an assembly, thereby reducing implementation costs. It should be apparent that while connector 710 provides cylindrical recesses 720 as internal recesses for accepting tubular members, connecter 710 can be configured to provide an outer diameter that cooperates with an inner diameter of a tubular member to connect tubular members together. In such an embodiment, connecter 710 may also be used with the various receptacles of the various central joints or corner joints used to construct frames 102, 122. Accordingly, connecter 710 may be used as a fastener to secure a tubular member to a corner or central joint to construct frames 102, 122.

While displays 100, 120 have been described as generally having a fabric covers 104, 124 draped over frames 102, 122, other embodiments for displays 100, 120 may be implemented in many different forms while achieving the desired objects and goals of the invention. For example, a horizontal cross-section of displays 100, 120 need not have four sides that meet at right angles, but rather displays 100, 120 can be implemented to have a circular or oval horizontal cross-section, or have horizontal cross-sections that have two, three or greater than four sides, with adjoining angles that need not be equilateral or any particularly angular measurement. Thus, displays 100, 120 may be implemented in generally cylindrical shapes that have horizontal cross-sections that are oval, triangular, or general polygons. Displays 100, 120 may also be implemented in such forms as cones, pyramids, or generally any geometric shape that can be realized in a three dimensional object.

In addition, displays 100, 120 can be constructed to have a generally solid outer framework in contrast to the typically flexible fabric covers 104, 124, so that frames 102, 122 are not required. For example, displays 100, 120 can be constructed of solid panels that are hinged or otherwise connected together to form a three dimensional shape that can simulate a stack of bulk goods or other promotional or marketing devices.

The foregoing description has been directed to particular embodiments of the present invention. It will be apparent, however, that other variations and modifications my be made to the described embodiments, with the attainment of some or all of their advantages. Therefore, it is the object of the appended claims to cover all such variations and modifications as come within the true spirit and scope of the invention.

What is claimed is:

1. A device for simulating stacked products, comprising:
a display member that describes a three dimensional volume and that includes spaced surfaces that describe an outer surface suitable for receiving a design that simulates a three dimensional stack of products;
a support structure interior to the outer surface and coupled to the display member for supporting the spaced surfaces; and
a retainer mechanism for retaining the display member to the support structure.

2. The device according to claim 1, further comprising a base member for supporting one or more of the display member or the support structure atop the base member.

3. The device according to claim 2, wherein the base member is a pallet.

4. The device according to claim 1, wherein at least one spaced surface is composed of a fabric material.

5. The device according to claim 1, wherein the support structure is a tubular frame.

6. The device according to claim 4, wherein the support structure is a tubular frame, and the fabric material is draped over the tubular frame to form the at least one spaced surface.

7. The device according to claim 4, further comprising wind slits in the at least one spaced surface.

8. The device according to claim 4, further comprising rain holes in an upper portion of the display member.

9. The device according to claim 2, wherein the support structure is a tubular frame.

10. The device according to claim 9, wherein the tubular frame further comprises fastening members being operative to permit the tubular frame to be fastened to the base.

11. The device according to claim 1, wherein the retainer mechanism further comprises a strap affixed to the outer surface, which strap is operative to engage a portion of the support structure to retain the display member to the support structure.

12. The device according to claim 2, wherein the retainer mechanism further comprises a strap affixed to the outer surface, which strap is operative to engage a portion of one or more of the support structure or the base to retain the display member to the one or more of the support structure or the base.

13. A method for simulating stacked products with a display, comprising:
providing a display member as a three dimensional volume including spaced surfaces that describe an outer surface suitable for receiving a design that simulates a three dimensional stack of products;
supporting the outer surface with a support structure; and
retaining the outer surface to the support structure.

14. The device according to claim 13, further comprising supporting one or more of the display member or the support structure with a base member.

15. The method according to claim 13, further comprising composing at least one spaced surface of a fabric material.

16. The method according to claim 13, further comprising providing the support structure as a tubular frame.

17. The method according to claim 16, further comprising draping a fabric material over the tubular frame to form the at least one spaced surface.

18. The method according to claim 15, further comprising providing wind slits in the at least one spaced surface.

19. The method according to claim 15, further comprising providing rain holes in an upper portion of the display member.

20. The method according to claim 14, further comprising fastening the support structure to the base.

21. The method according to claim 20, wherein retaining further comprises fastening the display member to one or more of the support structure or the base.

22. A device for simulating a stack of goods, comprising:
a substantially rigid structure that includes a surface describing a volume, the surface being suitable for receiving indicia that simulates a three dimensional stack of goods;
a retainer affixed to the structure for retaining the structure to another object; and
a pallet upon which the structure is mounted, the retainer as being fastenable to the pallet to retain the structure to the pallet.
